(19) United States
(12) Patent Application Publication
(10) Pub. No.: US 2024/0036533 A1
(43) Pub. Date: Feb. 1, 2024

(54) Method for Identifying a Process Model for Model-Based, Predictive Multivariable Control of a Process Installation

(71) Applicant: Siemens Aktiengesellschaft, Muenchen (DE)

(72) Inventor: Bernd-Markus PFEIFFER, Uttenreuth (DE)

(21) Appl. No.: 18/223,737

(22) Filed: Jul. 19, 2023

(30) Foreign Application Priority Data
Jul. 26, 2022 (EP) 22187089

(51) Int. Cl. G05B 13/04

(52) U.S. Cl. CPC G05B 13/048; G05B 13/041

(57) ABSTRACT

A computer-implemented method for the automated identification of a process model for a model-based, predictive multivariable control of a process installation, wherein reference is made to previously defined controlled variables, manipulated variables and disturbance variables for the model-based, predictive multivariable control of the process installation.

### BACKGROUND OF THE INVENTION

### 1. Field of the Invention

The invention relates to a control system for a technical installation, in particular manufacturing or process installation, and relates to a computer-implemented method for automated identification of a process model for a model-based, predictive multivariable control of a process installation, where reference is made to previously defined controlled variables, manipulated variables and disturbance variables for the model-based, predictive multivariable control of the process installation.

### 2. Description of the Related Art

Model-based, predictive controllers (model predictive control (MPC)) represent the most successful technical method for multivariable control in process engineering processes. These controls require a (usually linear) dynamic process model, which is usually identified from process data. A prerequisite for identifying process models from measured data is that the process is excited sufficiently strongly such that its dynamic behavior is identifiable in the measured data.

One problem here lies in the planning and implementation of special active tests in the installation that serve to generate measured data having an adequate information content in order to identify the process models.

In MPC applications, a distinction is made between three types of variables which are required to identify the process model: (i) controlled variables (CV), for which a setpoint value is to be specified at a later time, (ii) manipulated variables (MV), which are permitted to be adjusted by the MPC. These are usually setpoint values of existing controllers in the base automation of the process installation, and (iii) measurable disturbance variables (DV), which have a significant influence on controlled variables but cannot be adjusted actively by the MPC.

The usual, conventional method for the excitation of dynamic processes involves what are known as step tests. Here, all manipulated variables (MVs), which are to serve as input variables for the process model, are excited successively with a step or several steps of a suitable height and duration. The planning of such step tests requires, on the one hand, practical experience with the technical process(es) of the process installation. On the other hand, an in-depth understanding of control engineering is required in order to be able to generate “information-rich” measured data. The planning usually occurs during intensive discussions between the installation operator, the installation operatives on site, and the control engineering service provider that is to develop the MPC solution.

WO 2008/145154 A1 discloses a method for monitoring an automated production process.

### SUMMARY OF THE INVENTION

In view of the foregoing, it is therefore an object of invention to automate the identification of the process model for a model-based, predictive multivariable control of a process installation and to significantly reduce the outlay involved in the identification.

These and other objects and advantages are achieved in accordance with the invention by a control system and a computer-implemented method for automated identification of a process model for a model-based, predictive multivariable control of a process installation, where reference is made to previously defined controlled variables, manipulated variables and disturbance variables for the model-based, predictive multivariable control of the process installation. The method comprises:
providing historical measured data from a production operation of the process installation in an archive, where the manipulated variables were constant during the production operation,
determining the respective operating point of all manipulated variables and a respective operating point and a respective standard deviation of all controlled variables from the historical measured data,
specifying a permitted deviation of each controlled variable from the operating point of the respective controlled variable, where the permitted deviation particularly amounts to six times the standard deviation of the respective controlled variable,
sampling the controlled variables, manipulated variables and disturbance variables with a constant sampling time,
providing a respective low-pass filtration for the controlled variables, where the filter time constant is selected such that the standard deviation of the respective controlled variable is smaller by a factor of 2 to 6, preferably 3 to 5, with the low-pass filtration than without the low-pass filtration,
implementing the following steps consecutively for each manipulated variable:
   a) starting from the operating point, the manipulated variable is excited in a ramp-shaped manner until a value of at least one of the controlled variables lies outside a tolerance band about the respective operating point of the controlled variables, where the tolerance band amounts in each case to twice the standard deviation of the respective controlled variable,
   b) determining the excitation amplitude of the manipulated variable that was required in step a) for at least one of the controlled variables to leave the tolerance band,
   c) returning the manipulated variable to its operating point and waiting until each controlled variable once again has a steady state,
   d) exciting the manipulated variable in a stepped manner with the positive twofold excitation amplitude and waiting until each controlled variable once again has a steady state,
   e) exciting the manipulated variable in a stepped manner with the negative fourfold excitation amplitude and waiting until each controlled variable once again has a steady state,
   f) exciting the manipulated variable in a stepped manner with the positive twofold excitation amplitude and waiting until each controlled variable once again has a steady state, where during steps d), e) an immediate transition is made to the subsequent step if one of the controlled variables exceeds the specified permitted deviation, and
   g) storing the values of the controlled variables, manipulated variables and disturbance variables during the execution of steps a) to f) in a computer-implemented data memory, and
using the values of the controlled variables, manipulated variables and disturbance variables stored in the computer-implemented data memory for the automated identification of the process model for the model-based, predictive multivariable control of the process installation using a least error squares method.

The invention assumes that the controlled variables, manipulated variables and disturbance variables required for the process model have already been defined. Furthermore, in accordance with the method of the invention reference is made to measured data from a production operation of the process installation. Here, the manipulated variables have been kept constant during recording of the measured data.

The operating point of the manipulated variables and of the controlled variables can, if necessary, be read out from documentation data of an operator of the process installation. In order to determine the operating points, it can however also be necessary to calculate the mean value of the manipulated variable from the historical measured data in an automated manner.

Specification of the permitted deviation of the controlled variables from their operating point in each case can be based on information of an operator of the process installation. This serves to ensure a reliable operation of the process installation and compliance with a defined product quality. If no information of the installation operator is available, the permitted deviation can amount to six times the standard deviation of the respective controlled variable. This value has proven to be particularly suitable in test series.

The controlled variables, manipulated variables and disturbance variables are sampled with a constant sampling time, i.e., recorded with measurement technology, during execution of the method in accordance with the invention. Without being limited hereto, the sampling time can amount to 1 second, for example.

In order to suppress a high-frequency measurement noise, the controlled variables are each subjected to filtration by a low pass in a manner which is known per se. The remaining portion of the sampled controlled variable then represents the useful signal. The filter time constant of the low-pass filtration can amount, for example, to a value of 10 seconds, without being limited hereto.

The method steps a) to g) are implemented iteratively for each of the defined manipulated variables. The respective manipulated variable is firstly excited in a ramp-shaped manner in method step a). Expressed mathematically, a curve of the excitation is constant. In other words, the excitation does not occur in a stepped manner but instead in the shape of a ramp. Here, the ascending gradient of the ramp is relatively small. Viewed relatively, the ascending gradient of the ramp must be so small that the controlled variables can follow the ramp-shaped excitation with a certain “following error”. Here, during the method in accordance with the invention reference can be made to empirical values of installation operatives. An ascending gradient of the ramp of the manipulated variable can amount, for example, to 1% of a maximum value (of a maximum excitation amplitude) of the manipulated variable per second. The ramping-up of the ramp to the maximum value should take at least as long as the process would need following a stepped excitation in order to settle once again into a new steady state. In a typical process engineering process (distillation column, stirred-tank reactor), this can take several hours.

In subsequent steps d) to f), the manipulated variable is excited in a stepped manner, firstly upward with the twofold excitation amplitude, then downward with the fourfold excitation amplitude, and finally upward again with the twofold excitation amplitude. Here, a curve of the excitation is accordingly constant but not differentiable.

In each case, the method waits until each controlled variable has a steady state. The presence of the steady state is monitored, for example, by monitoring the gradient of the respective low-pass-filtered signal of the controlled variables. If the gradient is substantially zero in a defined time window, then a steady state can be assumed. Here, the length of the time window and the “residual gradient” still permitted depend as a rule on the process dynamics and can differ from one another for different process variables (controlled variables).

With the method in accordance with the invention, it is achieved in an automated manner that each controlled variable departs from its operating point by at least four times the respective standard deviation (in other words, by 4σ), where it settles into a new steady state. The process excitation thus stands out clearly from the normal measurement noise. In the case of a normally distributed process variable without strong external disturbance influences, it can be assumed that 99% of the measured values are located in a 3σ band about the operating point without active excitation.

At the same time, it is ensured that no controlled variable leaves the permitted deviation (for example, 6σ) about its operating point so as not to jeopardize safety and product quality. In this context, a “minimally invasive” process excitation is involved, which is precisely as strong as is necessary for the purpose of identification.

As a result of the sequence of three steps per manipulated variable (upward, fully downward, back to the center), a signal profile is achieved that is symmetrical to the respective operating point and that has a high information content for dynamic identification. The step sequence is structured such that switching forward to the next step compensates the effect of the previous step, so that a controlled variable that is currently in danger of violating a limit is thereby “reeled in” again, i.e., does not run away any further in the dangerous direction.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be explained below by way of example with reference to figures, in which:

FIG. 1 shows a stepped excitation of manipulated variables and a response of controlled variables thereto;

FIG. 2 shows a comparison of a sampled and a modeled temporal profile of a controlled variable; and

FIG. 3 is a flowchart of the method in accordance with the invention.

### DETAILED DESCRIPTION OF THE EXEMPLARY EMBODIMENTS

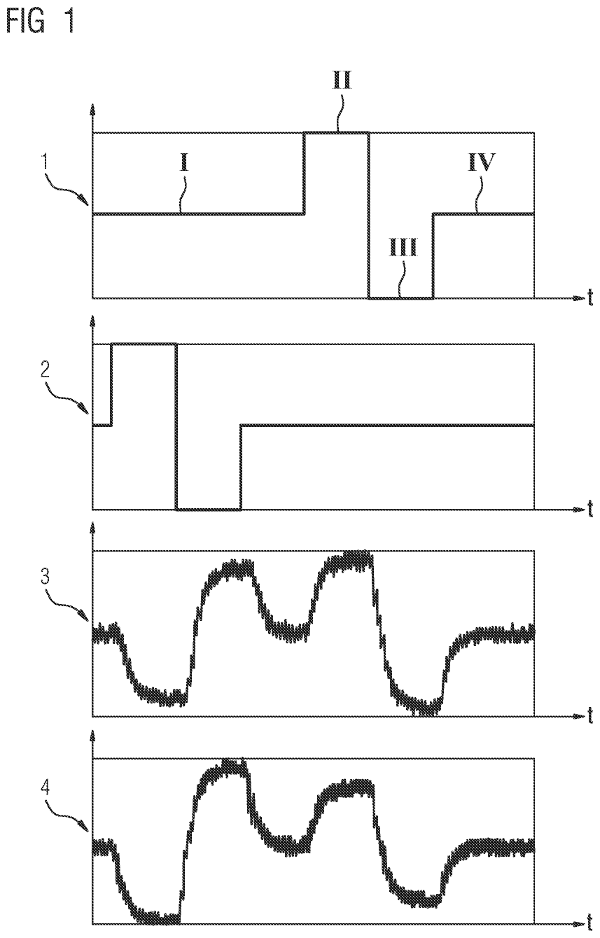

FIG. 1 shows signal value profiles of manipulated variables and controlled variables during the execution of steps d) to g) of a method in accordance with the invention. Here, this involves, by way of example, a 2×2 multivariable system with two manipulated variables and two controlled variables. The method in accordance with the invention is performed in order to identify a process model for a model-based, predictive control of the 2×2 multivariable system. Here, the previous method steps have already been performed.

FIG. 1 shows a first temporal profile 1 of a signal value of a first manipulated variable, a second temporal profile 2 of a signal value of a second manipulated variable, a third temporal profile 3 of a signal value of a first controlled variable, and a fourth temporal profile 4 of a signal value of a second controlled variable. Here, no numerical value is assigned to the signal values in each case.

In the first temporal profile 1, it can be seen that the manipulated variable is initially excited constantly with a mean value (region I). This is followed by a stepped increase by twice the previously determined excitation amplitude in an upward direction (region II). Subsequently, there is a downward step by four times the excitation amplitude (region III). Finally, there is once again an upward step by twice the excitation amplitude in order to re-attain the mean initial level (region IV).

The second temporal profile 2 shows a comparable profile of the second manipulated variable. However, the stepped excitations of the second manipulated variable have already occurred prior to the stepped excitations of the first manipulated variable.

The third temporal profile 3 and the fourth temporal profile 4 show the responses of the first and second controlled variable to the stepped excitations of the two manipulated variables. It can be seen clearly that, following a step of one of the two manipulated variables, the next step in each case does not occur until the controlled variables have a substantially steady state. These steady states can be recognized in the temporal profiles 3, 4 because the signal value of the respective controlled variable “levels out” at a certain value, i.e., the curve extends almost horizontally.

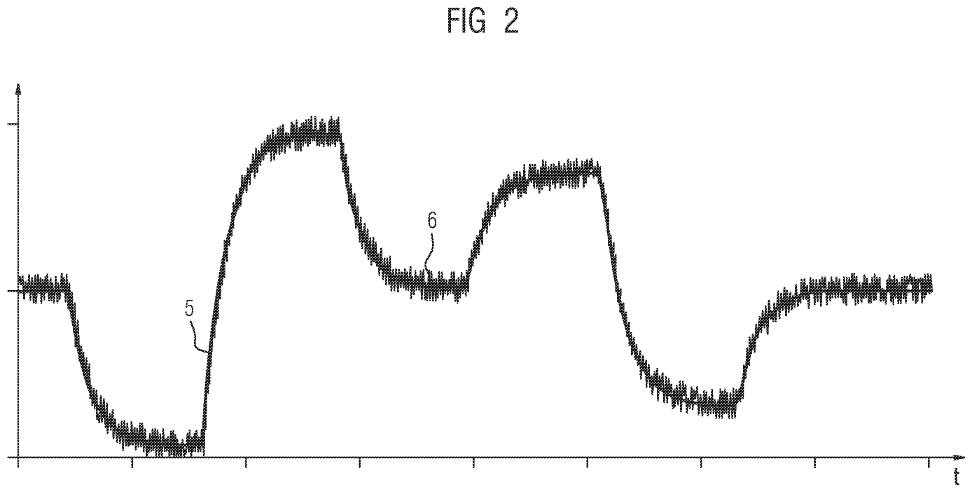

FIG. 2 shows, as a result of the identification of the process model, a modeled temporal profile 5 of the first controlled variable against the profile 6 of the first controlled variable which was recorded (sampled and filtered) via measurement technology. Here, the continuous curve extending without recognizable oscillations represents the modeled profile. Here, the curve oscillating upward and downward represents the profile that was recorded via measurement technology. It clearly evident that the modeled profile 5 very closely follows the profile 6 that was recorded via measurement technology. The process model identified with the aid of the method in accordance with the invention accordingly maps the actual process with a high quality.

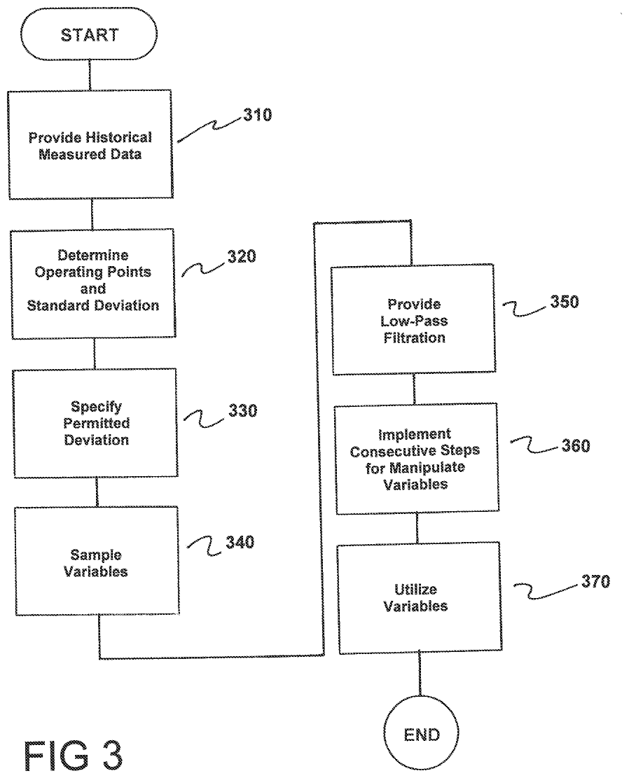

FIG. 3 is a flowchart of the computer-implemented method for automated identification of a process model for a model-based, predictive multivariable control of a process installation, where reference is made to previously defined controlled variables, manipulated variables and disturbance variables for the model-based, predictive multivariable control of the process installation.

The method comprises providing historical measured data from a production operation of the process installation in an archive, as indicated in step 310. Here, the manipulated variables were constant during the production operation.

Next, a respective operating point of all manipulated variables and a respective operating point and a respective standard deviation of all controlled variables from the historical measured data are determined, as indicated in step 320.

Next, a permitted deviation of each controlled variable is specified from the operating point of the respective controlled variable, as indicated in step 330. Here, the permitted deviation comprises six times the standard deviation of the respective controlled variable.

Next, the controlled variables, manipulated variables and disturbance variables are sampled with a constant sampling time, as indicated in step 340.

Next, a respective low-pass filtration for the controlled variables is provided, as indicated in step 350. In accordance with the method, a filter time constant of the low-pass filtration is selected such that the standard deviation of the respective controlled variable is smaller by a factor of 2 to 6 with the low-pass filtration than without the low-pass filtration.

Next, a series of step as implemented consecutively for each manipulated variable, as indicated in step 360. In the accordance with the method, the step comprises a) starting from the operating point, the manipulated variable is excited in a ramp-shaped manner until a value of at least one of the controlled variables lies outside a tolerance band about the respective operating point of the controlled variables, where each tolerance band is twice the standard deviation of the respective controlled variable; b) determining an excitation amplitude of the manipulated variable that was required during step a) for at least one of the controlled variables to depart from the tolerance band; c) returning the manipulated variable to its operating point and waiting until each controlled variable once again has a steady state; d) exciting the manipulated variable in a stepped manner with a positive twofold excitation amplitude and waiting until each controlled variable once again has the steady state; e)exciting the manipulated variable in a stepped manner with a negative fourfold excitation amplitude and waiting until each controlled variable once again has the steady state; f) exciting the manipulated variable in a stepped manner with the positive twofold excitation amplitude and waiting until each controlled variable once again has the steady state, where an immediate transition to a subsequent step occurs if one of the controlled variables exceeds a specified permitted deviation during steps d) and e); and g) storing the values of the controlled variables, manipulated variables and disturbance variables during execution of steps a) to f) in a computer-implemented data memory.

The method further includes utilizing the values of the controlled variables, manipulated variables and disturbance variables stored in the computer-implemented data memory for the automated identification of the process model for the model-based, predictive multivariable control of the process installation utilizing a least error squares method, as indicated in step 370.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A computer-implemented method for automated identification of a process model for a model-based, predictive multivariable control of a process installation, reference being made to previously defined controlled variables, manipulated variables and disturbance variables for the model-based, predictive multivariable control of the process installation, the method comprising:
providing historical measured data from a production operation of the process installation in an archive, the manipulated variables being constant during the production operation;
determining a respective operating point of all manipulated variables and a respective operating point and a respective standard deviation of all controlled variables from the historical measured data;
specifying a permitted deviation of each controlled variable from the operating point of the respective controlled variable, the permitted deviation comprising six times the standard deviation of the respective controlled variable;
sampling the controlled variables, manipulated variables and disturbance variables with a constant sampling time;
providing a respective low-pass filtration for the controlled variables, a filter time constant of the low-pass filtration being selected such that the standard deviation of the respective controlled variable is smaller by a factor of 2 to 6 with the low-pass filtration than without the low-pass filtration;
implementing the following steps consecutively for each manipulated variable:
a) starting from the operating point, the manipulated variable is excited in a ramp-shaped manner until a value of at least one of the controlled variables lies outside a tolerance band about the respective operating point of the controlled variables, each tolerance band being twice the standard deviation of the respective controlled variable;
b) determining an excitation amplitude of the manipulated variable which was required during step a) for at least one of the controlled variables to depart from the tolerance band;
c) returning the manipulated variable to its operating point and waiting until each controlled variable once again has a steady state;
d) exciting the manipulated variable in a stepped manner with a positive twofold excitation amplitude and waiting until each controlled variable once again has the steady state;
e) exciting the manipulated variable in a stepped manner with a negative fourfold excitation amplitude and waiting until each controlled variable once again has the steady state;
f) exciting the manipulated variable in a stepped manner with the positive twofold excitation amplitude and waiting until each controlled variable once again has the steady state, an immediate transition to a subsequent step occurring if one of the controlled variables exceeds a specified permitted deviation during steps d) and e); and
g) storing the values of the controlled variables, manipulated variables and disturbance variables during execution of steps a) to f) in a computer-implemented data memory; and
utilizing the values of the controlled variables, manipulated variables and disturbance variables stored in the computer-implemented data memory for the automated identification of the process model for the model-based, predictive multivariable control of the process installation utilizing a least error squares method.

2. The method as claimed in claim 1, wherein a mean value of the manipulated variable is calculated from the historical measured data to determine each respective operating point.

3. The method as claimed in claim 1, wherein the identified process model is utilized during operation of the process installation for the model-based, predictive multivariable control of the process installation.

4. The method as claimed in claim 2, wherein the identified process model is claim during operation of the process installation for the model-based, predictive multivariable control of the process installation.

5. The method as claimed in claim 1, wherein the standard deviation of the respective controlled variable is smaller by a factor of 3 to 5.

6. A control system for a technical installation, comprising a computer including a processor and memory;
wherein the processor is configured to:
provide historical measured data from a production operation of a process installation in an archive, the manipulated variables being constant during the production operation;
determine a respective operating point of all manipulated variables and a respective operating point and a respective standard deviation of all controlled variables from the historical measured data;
specify a permitted deviation of each controlled variable from the operating point of the respective controlled variable, the permitted deviation comprising six times the standard deviation of the respective controlled variable;
sample the controlled variables, manipulated variables and disturbance variables with a constant sampling time;
provide a respective low-pass filtration for the controlled variables, a filter time constant of the low-pass filtration being selected such that the standard deviation of the respective controlled variable is smaller by a factor of 2 to 6 with the low-pass filtration than without the low-pass filtration; and
implement the following steps consecutively for each manipulated variable:
a) starting from the operating point, the manipulated variable is excited in a ramp-shaped manner until a value of at least one of the controlled variables lies outside a tolerance band about the respective operating point of the controlled variables, each tolerance band being twice the standard deviation of the respective controlled variable;
b) determining an excitation amplitude of the manipulated variable which was required during step a) for at least one of the controlled variables to depart from the tolerance band;
c) returning the manipulated variable to its operating point and waiting until each controlled variable once again has a steady state;
d) exciting the manipulated variable in a stepped manner with a positive twofold excitation amplitude and waiting until each controlled variable once again has the steady state;
e) exciting the manipulated variable in a stepped manner with a negative fourfold excitation amplitude and waiting until each controlled variable once again has the steady state;
f) exciting the manipulated variable in a stepped manner with the positive twofold excitation amplitude and waiting until each controlled variable once again has the steady state, an immediate transition to a subsequent step occurring if one of the controlled variables exceeds a specified permitted deviation during steps d) and e); and
g) storing the values of the controlled variables, manipulated variables and disturbance variables during execution of steps a) to f) in a computer-implemented data memory;
wherein the values of the controlled variables, manipulated variables and disturbance variables stored in the computer-implemented data memory are utilized for the automated identification of the process model for the model-based, predictive multivariable control of the process installation utilizing a least error squares method.

7. The control system of claim 6, wherein the technical installation comprises a manufacturing installation or process installation.

8. A computer program product which, when executed by a data processing facility, performs the method as claimed in claim 1.
